(19) United States
(12) Patent Application Publication
(10) Pub. No.: US 2015/0074234 A1
(43) Pub. Date: Mar. 12, 2015

(54) CONTENT SYSTEM AND METHOD FOR CHUNK-BASED CONTENT DELIVERY

(71) Applicant: ELECTRONICS AND TELECOMMUNICATIONS RESEARCH INSTITUTE, Daejeon (KR)

(72) Inventor: Jeong Yun KIM, Daejeon (KR)

(73) Assignee: ELECTRONICS AND TELECOMMUNICATIONS RESEARCH INSTITUTE, Daejeon (KR)

(21) Appl. No.: 14/265,808

(22) Filed: Apr. 30, 2014

(30) Foreign Application Priority Data
Sep. 11, 2013 (KR) 10-2013-0108949

(51) Int. Cl. H04L 12/721; H04L 29/08; H04L 29/06

(52) U.S. Cl. CPC H04L 45/38; H04L 65/1023; H04L 67/2842
USPC 709/219

(57) ABSTRACT

A content system and method in which content may be divided into chunks and distributed and stored in content routers or content servers, content routing information corresponding to information on the distributed and stored content may be provided to a client terminal when a request for the content is received from the client terminal, and the client terminal may receive the distributed and stored content in chunk units based on the received content routing information.

### CROSS-REFERENCE TO RELATED APPLICATION

This application claims the benefit of Korean Patent Application No. 10-2013-0108949, filed on Sep. 11, 2013, in the Korean Intellectual Property Office, the disclosure of which is incorporated herein by reference.

### BACKGROUND

1. Field of the Invention

The present invention relates to technology for content delivery, and more particularly, to technology that may divide content into chunks and deliver the content through content routers.

2. Description of the Related Art

With a recent extension of utilization of smart terminals, services for requesting content provision are increasing. In providing such a content delivery service, a service response speed is considered a significant performance index. Thus, a content routing system may redirect a request for content to a content server disposed closest to a user device, among content servers storing the content requested by a user.

An existing content routing system may perform redirection based on a content file unit using a domain name system (DNS) or a hypertext transfer protocol (HTTP).

As an example of conventional content delivery technology, Korean Patent No. 1218574 published on Jan. 21, 2013 discloses “Delivering contents by using storage of network”. In the prior art, to deliver content from a content provider to a user terminal, the content may be stored in an entity for packet routing. When a request for the content is received from the user terminal, a network may verify whether an entity storing the requested content is present, for example, whether the requested content is present in the network. Based on a result of the verification, the content may be delivered to the user terminal.

In the prior art, content may be delivered using a network entity, similar to a router. However, since the entire content is stored and transmitted, loads may be concentrated on several network entities.

Thus, there is a demand for technology that may reduce a load of a network entity and increase content transmission efficiency.

### SUMMARY

In order to resolve the issues described above, an aspect of the present invention provides a content system and method for chunk-based content delivery.

In detail, the method in which routing information and cache information of content distributed and stored in multiple content routers or content servers in chunk units may be managed, and the content may be delivered in chunk units based on the corresponding information.

Another aspect of the present invention also provides a content routing system that may identify content routers storing respective chunks constituting content when a content request message to request the content is received, and transmit content routing information including information on the identified content routers.

Still another aspect of the present invention also provides a client terminal that may transmit a content request message to a content routing system, receive content routing information from the content routing system, request and receive chunks constituting content from content routers storing the respective chunks based on the received content routing information, and play back the received chunks.

According to an aspect of the present invention, there is provided a method of receiving content in a client terminal, the method including transmitting, to a content routing system, a content request message to request content, receiving content routing information related to the content from the content routing system, transmitting, to content routers storing respective chunks constituting the content, chunk request messages to request the respective chunks based on the content routing information, receiving the chunks from the content routers, and playing back the received chunks.

The content routing information may include at least one of a number of the chunks constituting the content, information on sizes of the chunks, information on identifications (IDs) of the content routers storing the respective chunks, information on priorities of the content routers, information on loads of the content routers, locations of the content routers, performance information of the content routers, information on network states between the client terminal and the content routers, and information on optimal content routers to receive the chunks.

The transmitting of the chunk request messages may include determining an optimal content router for each chunk based on the received content routing information and network states between the client terminal and the content routers, and transmitting a chunk request message to the optimal content router.

The method may further include requesting the content from a content provider portal and receiving an address of the content routing system before the content request message is transmitted.

The receiving of the content routing information related to the content may include extracting, as the content routing information, information included in a response message based on a status code of the response message when the response message is received from the content routing system.

The receiving of the chunks may include extracting a chunk from a response message based on a status code of the response message when the response message is received from the content routing system.

According to another aspect of the present invention, there is also provided a method of delivering content in a content routing system, the method including receiving a content request message to request content from a client terminal, identifying content routers storing respective chunks constituting the content, and transmitting, to the client terminal, content routing information including information on the identified content routers.

The content may be divided into chunks of predetermined sizes, and distributed and stored in at least one content router.

The transmitting of the content routing information may include identifying an optimal content router for each of the chunks constituting the content to receive the corresponding chunk based on at least one of a location of the client terminal, locations of the identified content routers, priorities of the identified content routers, loads of the identified content routers, performance information of the identified content routers, and networks states between the client terminal and the identified content routers, including information on the optimal content router in the content routing information, and transmitting the content routing information.

The transmitting of the content routing information may include generating a response message including the content routing information for each chunk in response to the content request message, and setting a status code of the response message and transmitting the response message.

According to still another aspect of the present invention, there is also provided a client terminal that receives content, the client terminal including a content requester to transmit, to a content routing system, a content request message to request content, a router identifier to receive content routing information related to the content from the content routing system, and identify content routers storing respective chunks constituting the content based on the received content routing information, a chunk requester to transmit, to the identified content routers, chunk request messages to request the chunks, and receive the chunks from the content routers, and a content playback unit to play back the received chunks.

The router identifier may determine an optimal content router for each chunk based on the received content routing information and network states between the client terminal and the content routers, and the chunk requester may transmit a chunk request message to the optimal content router.

According to yet another aspect of the present invention, there is also provided a content routing system for delivering content, the content routing system including a routing database to store, for each content, information on chunks constituting each corresponding content and information on content routers storing the respective chunks, a router identifier to identify content routers storing respective chunks constituting requested content in the routing database when a content request message to request the content is received from a client terminal, and an information provider to transmit, to the client terminal, content routing information including information on the identified content routers.

The routing database may include at least one of information on sizes of the chunks, information on IDs of the content routers storing the respective chunks, information on priorities of the content routers, information on loads of the content routers, locations of the content routers, and performance information of the content routers.

The routing identifier may identify an optimal content router for each of the chunks constituting the content to receive the corresponding chunk based on at least one of a location of the client terminal, locations of the identified content routers, priorities of the identified content routers, loads of the identified content routers, performance information of the identified content routers, and networks states between the client terminal and the identified content routers, and the information provider may include information on the optimal content router in the content routing information, and transmit the content routing information.

According to further another aspect of the present invention, there is also provided a content system that delivers content, the content system including a content routing system to identify content routers storing respective chunks constituting content when a content request message to request the content is received, and transmit content routing information including information on the identified content routers, and a client terminal to transmit the content request message to the content routing system, request and receive chunks constituting the content from the content routers storing the respective chunks based on content routing information when the content routing information is received from the content routing system, and play back the received chunks.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a content system according to an embodiment of the present invention;

FIG. 2 is a diagram illustrating a method of delivering content in a content system according to an embodiment of the present invention;

FIG. 3 is a block diagram illustrating a configuration of a client terminal in a content system according to an embodiment of the present invention;

FIG. 4 is a block diagram illustrating a configuration of a content routing system in a content system according to an embodiment of the present invention;

FIG. 5 is a table illustrating an example of a routing database storing content routing information according to an embodiment of the present invention;

FIG. 6 is a flowchart illustrating a method of receiving content in a client terminal according to an embodiment of the present invention; and

FIG. 7 is a flowchart illustrating a method of providing content routing information in a content routing system according to an embodiment of the present invention.

### DETAILED DESCRIPTION

Other purposes and features of the present invention will be apparent from the description provided herein with reference to the accompanying drawings.

Reference will now be made in detail to exemplary embodiments of the present invention, examples of which are illustrated in the accompanying drawings. When it is determined that a detailed description is related to a related known function or configuration which may make the purpose of the present disclosure unnecessarily ambiguous in the description, such a detailed description will be omitted.

However, the present invention is not limited to the exemplary embodiments set forth herein. Like reference numerals refer to the like elements throughout.

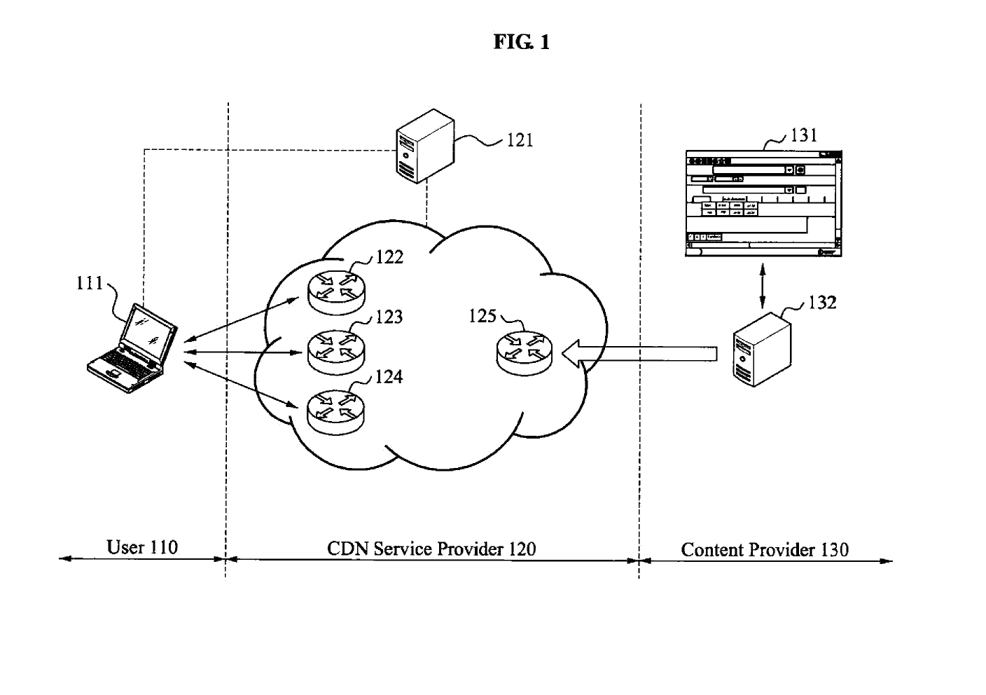

Hereinafter, a content system and method for chunk-based content delivery according to an embodiment of the present invention will be described with reference to FIGS. 1 through 7.

FIG. 1 is a diagram illustrating a configuration of a content system according to an embodiment of the present invention.

Referring to FIG. 1, a content delivery service in the content system may include a user area 110, a content delivery network (CDN) service provider area 120, and a content provider area 130.

In the user area 110, a user may request content using a client terminal 111, for example, a smart phone, a smart television (TV), an internet protocol television (IPTV), and a personal computer (PC).

The CDN service provider area 120 may include a plurality of content routers and/or a plurality of content servers 122, 123, 124, and 125, and a content routing system 121. The content routing system 121 may also be referred to as a request-routing system. The CDN service provider area 120 may distribute and store content based on chunk units. The content routing system 121 may provide the client terminal 111 with information on locations of content routers and/or content servers storing content requested by the client terminal 111. The content may be stored in chunk units. Since distinction between a content router and a content server is a matter of implementation, the content router and the content server may be considered the same, and in the description provided hereinafter the term “content router” will also be used in this regard.

The content provider area 130 may include a content provider portal 131 to provide owned content information, and an origin server 132 to store content. The content provider portal 131 may be a content provider server that provides a content provider portal.

The content provider area 130 may distribute and store the content stored in the origin server 132 to and in the content routers 122 through 125 in advance, and provide corresponding information to the content routing system 121. Although not shown in FIG. 1 for clarity of description, the origin server 132 may store content in the content routers 122 through 125 in advance and while the service is being processed. The content routing system 122 may inquire with the content routers 122 through 125 for content storage information, as necessary.

The origin server 132 may store content in a plurality of content routers and prepare a content delivery service in advance. The client terminal 111 may be provided with access information, for example, a uniform resource locator (URL) or an internet protocol (IP) address, of the content routing system 121 from the content provider portal 131 or when the system is initialized.

The client terminal 111 may request the content routing system 121 to deliver the content. The request for content delivery may be a request for chunk-based content delivery. The content routing system 121 may determine optimal routers based on priorities and loads, among the content routers 122 through 125 storing the requested content, and provide content routing information to the client terminal 111, in lieu of the content.

The client terminal 111 may select an optimal router from content routers storing a first chunk based on the received content routing information and a current network state, and transmit, to the selected optimal router, a message to request the first chunk. The content router receiving the request for the first chunk may transmit the requested chunk to the client terminal 111.

The client terminal 111 may select an optimal content router with respect to a subsequent chunk, transmit a message to request the corresponding chunk, and receive the requested chunk.

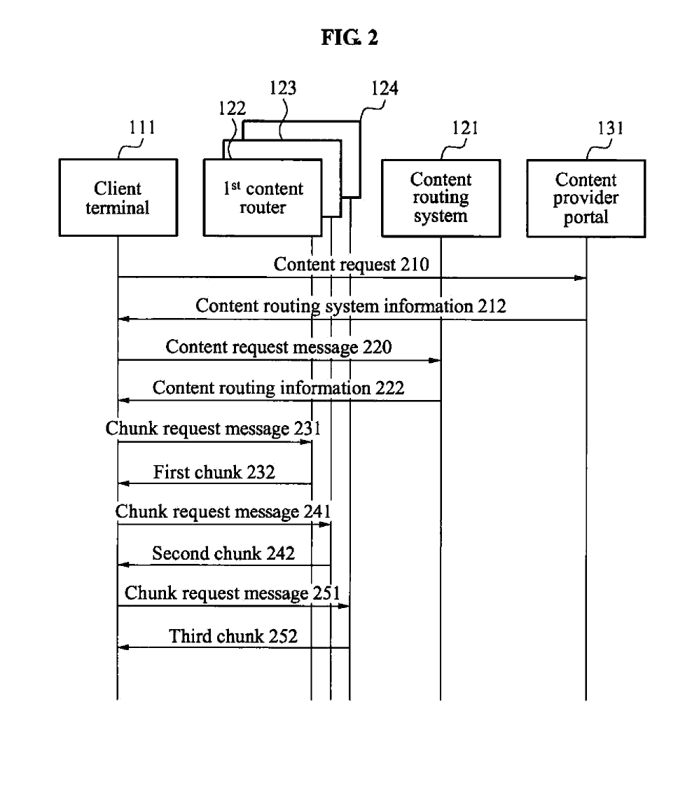

FIG. 2 is a diagram illustrating a method of delivering content in a content system according to an embodiment of the present invention.

Referring to FIG. 2, in operation 210, the client terminal 111 of FIG. 1 may access the content provider portal 131 in the content provider area 130 to request content. In operation 212, the content provider portal 131 may provide, to the client terminal 111, content routing system information, for example, an address (a URL or an IP address) of the content routing system 121, and information on available content. In operation 210, the request for the content may be transmitted through a hypertext transfer protocol (HTTP) request (GET) message including a content name. In operation 212, the content routing system information provided in response to the request for the content may be transmitted through an HTTP response (Code: 200 OK) message.

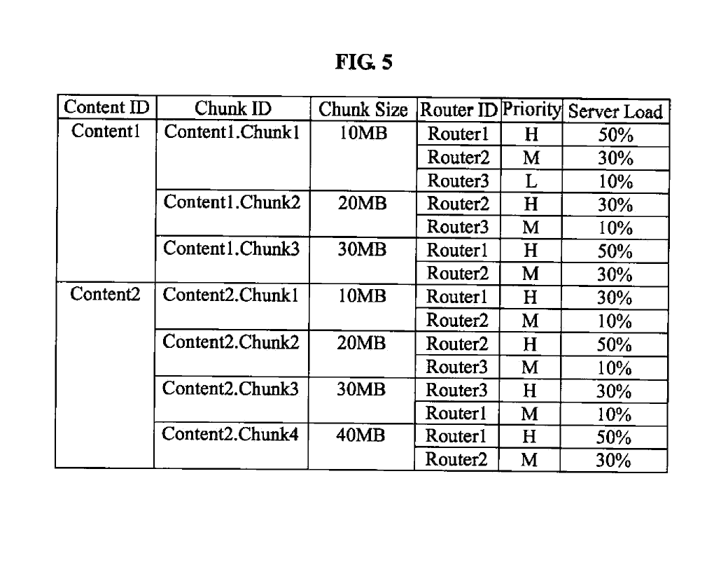

In operation 220, the client terminal 111 may transmit, to the content routing system 121, a content request message to request the content based on the content routing system information provided from the content provider portal 131. In operation 222, the content routing system 121 may transmit, to the client terminal 111, content routing information based on a content routing table or a routing database as illustrated in FIG. 5. The content routing information may include at least one of information on optimal content routers, and all information on content routers storing the requested content. In operation 220, the content request message may be transmitted through the HTTP request (GET) message including the content name. In operation 222, the content routing information may be transmitted through an HTTP response (status code 300: Multiple Choice) message including content routing information for each chunk.

The client terminal 111 may select content routers to request chunks based on the content routing information and network states, and sequentially or simultaneously transmit, to the respective content routers, chunk request messages to request the chunks in operations 231, 241, and 251.

In operations 232, 242, and 252, the client terminal 111 may receive the requested chunks, for example, a first chunk, a second chunk, and a third chunk, in response to the chunk request messages.

In operations 231, 241, and 251, the chunk request messages may be transmitted through an HTTP request (GET) message including a content byte range or a chunk name, for example a URL. In operations 232, 242, and 252, the chunks may be received through an HTTP response (status code 206: Partial content) message including the requested chunks.

The client terminal 111 may repeatedly perform the above-described process based on the received content routing information until all chunks are received. Since a code value included in a response message is independent from a protocol, the above-described process may be applicable to an HTTP protocol, an information-centric networking (ICN) protocol, and a domain name system (DNS) protocol.

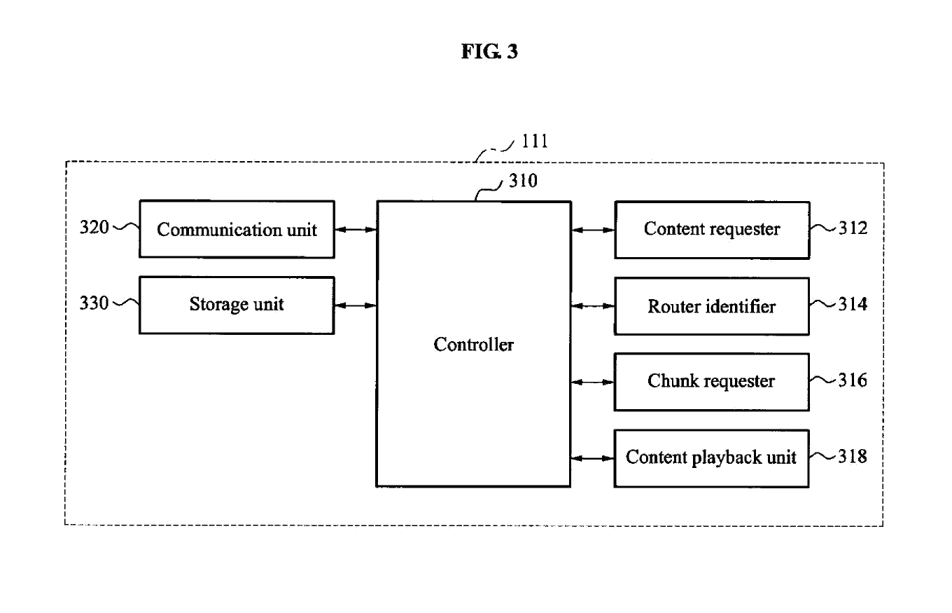

FIG. 3 is a block diagram illustrating a configuration of the client terminal 111 in the content system of FIG. 1.

Referring to FIG. 3, the client terminal 111 may include a controller 310, a content requester 312, a router identifier 314, a chunk requester 316, a content playback unit 318, a communication unit 320, and a storage unit 330.

The communication unit 320 may refer to a communication interface apparatus including a receiver and a transmitter. The communication unit 320 may transmit and receive data in a wired or wireless manner. The communication unit 320 may communicate with a content provider server that provides the content provider portal 131, the content routing system 121, and the content routers 122, 123, 124, and 125.

The storage unit 330 may store application programs, and an operating system to control an overall operation of the client terminal 111. The storage unit 330 may store received content routing system information, content routing information, chunks, and content generated by combining the chunks.

The content requester 312 may transmit, to the content routing system 121, a content request message to request content.

The content requester 312 may request the content from the content provider portal 131 and receive an address of the content routing system 121 before the content request message is transmitted.

The router identifier 314 may receive content routing information related to the content from the content routing system 121, and identify content routers storing respective chunks constituting the content based on the received content routing information.

The content routing information may include at least one of a number of the chunks constituting the content, information on sizes of the chunks, information on identifications (IDs) of the content routers storing the respective chunks, information on priorities of the content routers, information on loads of the content routers, locations of the content routers, performance information of the content routers, information on network states between the client terminal and the content routers, and information on optimal content routers to receive the chunks.

The router identifier 314 may determine an optimal content router for each chunk based on the received content routing information and network states between the client terminal and the content routers.

The chunk requester 316 may transmit, to the identified content routers, chunk request messages to request the chunks, and receive the requested chunks from the content routers. The chunk requester 316 may request the chunks one at a time, or may simultaneously request the plurality of chunks.

When optimal content routers are determined by the router identifier 314, the chunk requester 316 may transmit a chunk request message to an optimal content router determined for each chunk.

The chunk requester 316 may transmit a request for a single chunk to a single content router, or may transmit a request for a single chunk to content routers storing the corresponding chunk and store an initially received chunk.

When all of the chunks constituting the content are received by the chunk requester 316, the content playback unit 318 may play back the content by combining the received chunks. In another example, the content playback unit 318 may playback a previously received chunk while receiving another chunk.

The controller 310 may control an overall operation of the client terminal 111. The controller 310 may perform functions of the content requester 312, the router identifier 314, the chunk requester 316, and the content playback unit 318. The controller 310, the content requester 312, the router identifier 314, the chunk requester 316, and the content playback unit 318 are separately illustrated in FIG. 3 in order to describe each function separately. Thus, the controller 310 may include at least one processor configured to perform all or a portion of the functions of the content requester 312, the router identifier 314, the chunk requester 316, and the content playback unit 318.

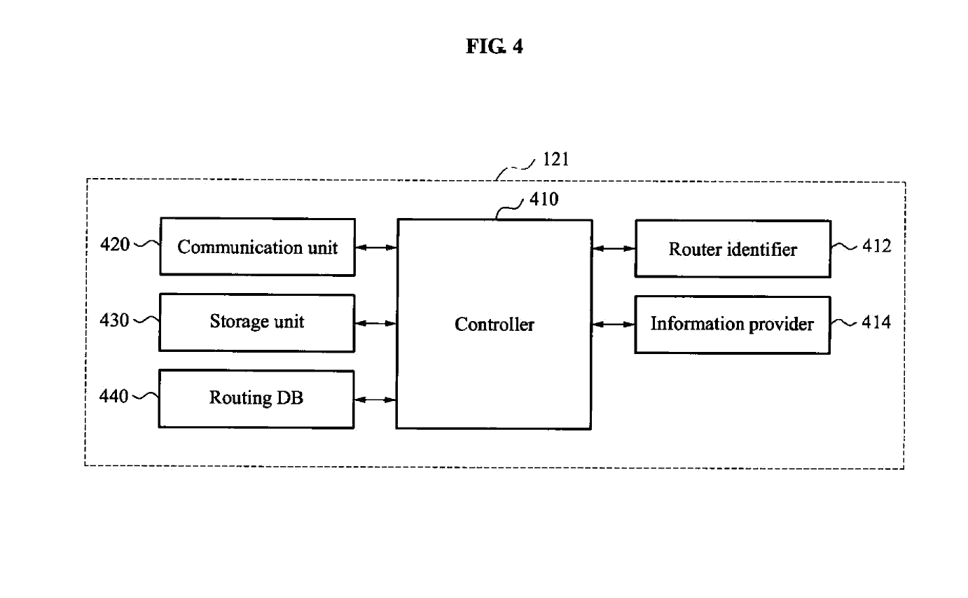

FIG. 4 is a block diagram illustrating a configuration of the content routing system 121 in the content system of FIG. 1.

Referring to FIG. 4, the content routing system 121 may include a controller 410, a router identifier 412, an information provider 414, a communication unit 420, a storage unit 430, and a routing database 440.

The communication unit 420 may refer to a communication interface apparatus including a receiver and a transmitter. The communication unit 420 may transmit and receive data in a wired or wireless manner. The communication unit 420 may communicate with a content provider server that provides the content provider portal 131, the origin server 132, a client terminal 111, and the content routers 122, 123, 124, and 125.

The storage unit 430 may store application programs, and an operating system to control an overall operation of the content routing system 121. The storage unit 430 may include the routing database 440.

The routing database 440 may store, for each content, information on chunks constituting each corresponding content and information on content routers storing the respective chunks, as shown in an example of FIG. 5.

FIG. 5 is, a table illustrating an example of a routing database storing content routing information according to an embodiment of the present invention.

Referring to FIG. 5, the routing database 440 of FIG. 4 may include information on sizes of chunks, information on IDs of content routers storing the respective chunks, information on priorities of the content routers, information on loads of the content routers, locations of the content routers, and performance information of the content routers.

The content routing system 121 of FIG. 1 may generate and manage an entry of the routing database 440 based on locations at which the content is stored, loads of the content routers, and priorities of the content routers received from the origin server 132 or the content routers (or content servers).

An entry ID of the routing database 440 may include a content ID and a chunk ID. The entry ID may be used as a search index to generate and manage content routing information.

When a content request message to request the content is received from the client terminal 111, the router identifier 412 may identify content routers storing respective chunks constituting the requested content in the routing database 440.

The router identifier 412 may determine an optimal content router for each of the chunks constituting the content to receive the corresponding chunk based on at least one of the location of the client terminal 111, locations of the identified content routers, priorities of the identified content routers, loads of the identified content routers, performance information of the identified content routers, and networks states between the client terminal 111 and the identified content routers.

The information provider 414 may transmit, to the client terminal 111, content routing information including information on content routers storing the chunks of the requested content.

When an optimal content router for each chunk is determined by the router identifier 412, the information provider 414 may include information on the optimal content router in the content routing information, and transmit the content routing information.

The controller 410 may control an overall operation of the content routing system 121. The controller 410 may perform functions of the router identifier 412 and the information provider 414. The controller 410, the router identifier 412, and the information provider 414 are separately illustrated in FIG. 4 in order to describe each function separately. Thus, the controller 410 may include at least one processor configured to perform all or a portion of the functions of the router identifier 412 and the information provider 414.

Hereinafter, a method for chunk-based content delivery according to an embodiment of the present invention will be described with reference to the drawings.

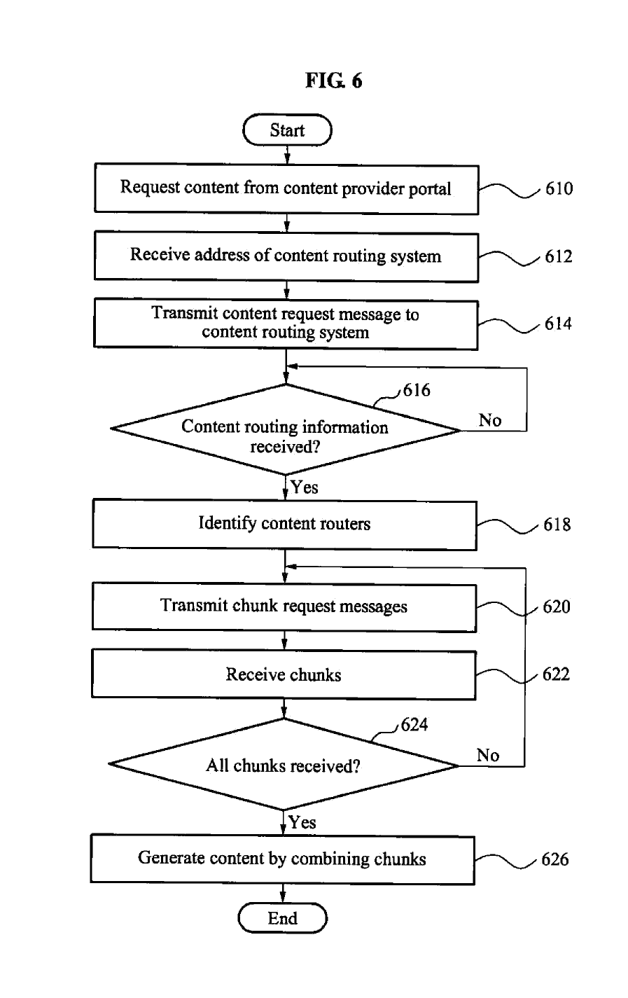

FIG. 6 is a flowchart illustrating a method of receiving content in a client terminal 111 according to an embodiment of the present invention.

Referring to FIG. 6, in operation 610, the client terminal 111 of FIG. 1 may request content from the content provider portal 131. In operation 612, the client terminal 111 may receive an address of the content routing system 121 from the content provider portal 131.

In operation 614, the client terminal 111 may transmit, to the content routing system 121, a content request message to request the content using the address of the content routing system 121.

When content routing information related to the content is verified to be received from the content routing system 121 in operation 616, the client terminal 111 may identify content routers storing chunks constituting the content based on the content routing information in operation 618.

When a response message is received from the content routing system 121 in operation 616, the client terminal 111 may extract, as the content routing information, information included in the response message based on a status code of the response message.

In operation 620, the client terminal 111 may select at least one content router from content routers storing a chunk yet to be received, and transmit, to the selected at least one content router, a chunk request message to request the corresponding chunk.

In this example, a single content router for a single chunk may be selected, or a plurality of content routers for a plurality of chunks may be selected. The client terminal 111 may simultaneously request multiple chunks.

The content routers may be selected based on at least one of a sequence of the chunks, network states between the client terminal 111 and the content routers storing the respective chunks, information on priorities of the content routers, loads of the content routers, location of the content routers, performance information of the content routers, and a sequence of optimal content routers.

In operation 622, the client terminal 111 may receive the chunks constituting the content from the content routers. In operation 624, the client terminal 111 may verify whether all of the chunks constituting the content are received.

When response messages are received from the content routers in operation 622, the client terminal 111 may extract chunks included in the response messages based on status codes of the response messages.

When it is verified in operation 624 that all of the chunks constituting the content are yet to be received, the client terminal 111 may return to operation 620 and re-perform all subsequent operations.

When it is verified in operation 624 that all of the chunks constituting the content are received, the client terminal 111 may generate the content by combining the received chunks in operation 626. In this example, the client terminal 111 may play back the received chunks, rather than combining the received chunks into the content.

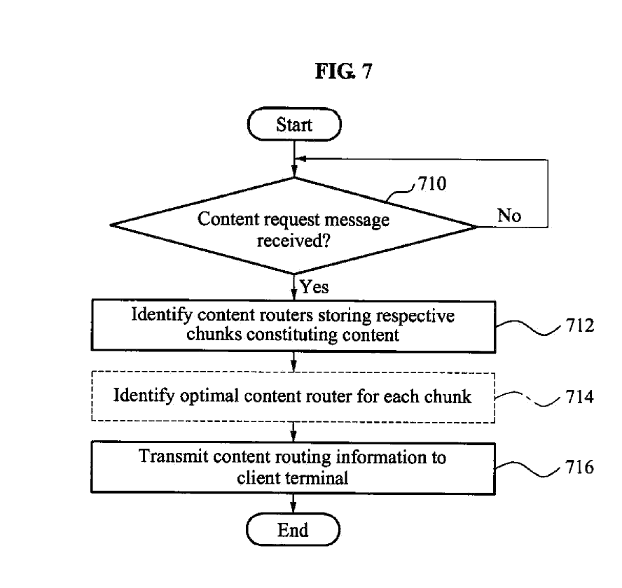

FIG. 7 is a flowchart illustrating a method of providing content routing information in the content routing system 121 of FIG. 1.

Referring to FIG. 7, when a content request message to request content is received from a client terminal 111 in operation 710, the content routing system 121 may identify content routers storing respective chunks constituting the content.

In operation 714, the content routing system 121 may identify an optimal content router for each of the chunks constituting the content to receive the corresponding chunk based on at least one of a location of the client terminal 111, locations of the identified content routers, priorities of the identified content routers, loads of the identified content routers, performance information of the identified content routers, and networks states between the client terminal 111 and the identified content routers.

In this example, the content routing system 121 may perform or omit operation 714 based on settings or a request from the client terminal 111.

In operation 716, the content routing system 121 may transmit, to the client terminal 111, content routing information including information on content routers storing the respective chunks.

In operation 716, the content routing system 121 may generate a response message including the content routing information for each chunk in response to the content request message, set a status code of the response message to be a preset value indicating that the content routing information is, included therein, and transmit the response message.

In a case in which operation 714 is performed, the content routing system 121 may transmit, to the client terminal 111, content routing information including information on the identified optimal content router in operation 716.

According to embodiments of the present invention, content may be divided into chunks and distributed and stored in multiple content routers or content servers disposed close to a user, and content routing information corresponding to information on the distributed and stored content may be provided to a client in response to a request for the content, whereby a content transmission delay may be reduced.

The method for chunk-based content delivery according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1-16. (canceled)

17. A method of delivering content in a content routing system, the method comprising:
receiving a content request message to request content from a client terminal;
identifying content routers storing the content by routing the content request message;
determining, from among the identified content routers, an optimal content router that transmits the content to the client terminal.

18. The method of claim 17, wherein the content is divided into chunks of predetermined sizes, and distributed and stored in at least one content router.

19. The method of claim 17, wherein the determining determine the optimal content router using at least one of location of the client terminal, locations of the content routers, and information on network states between the client terminal and the content routers.

20. The method of claim 17, further comprising
transmitting, to the client terminal, at least one of locations of the content routers and information on network states between the client terminal and the content routers.

21. The method of claim 17, further comprising
managing a cache information of the content distributed and stored in the content routers in chunk units.

22. The method of claim 17, wherein the identifying identifies content routers storing at least one chunk using content identification information,
wherein the at least one chunk constitutes the content.

23. A content routing system for delivering content, the content routing system comprising:
a receiver to receive a content request message to request content from a client terminal; and
a router identifier to identify content routers storing the content and determine, from among the identified content routers, an optimal content router that transmits the content to the client terminal

24. The content routing system of claim 23, wherein the content is divided into chunks of predetermined sizes, and distributed and stored in at least one content router.

25. The content routing system of claim 23, wherein the router identifier determines the optimal content router using at least one of location of the client terminal, locations of the content routers, and information on network states between the client terminal and the content routers.

26. The content routing system of claim 23, wherein the content routing system further comprises information provider to transmit, to the client terminal, at least one of locations of the content routers and information on network states between the client terminal and the content routers.

27. The content routing system of claim 23, wherein the content routing system manages a cache information of the content distributed and stored in the content routers in chunk units

28. The content routing system of claim 23, wherein the router identifier identifies content routers storing at least one chunk using content identification information,
wherein the at least one chunk constitutes the content.
